(19) United States
(12) Patent Application Publication
(10) Pub. No.: US 2020/0290352 A1
(43) Pub. Date: Sep. 17, 2020

(54) LIQUID DISCHARGE HEAD AND LIQUID DISCHARGE APPARATUS

(71) Applicants: Kohta Akiyama, Kanagawa (JP); Yusuke Nonoyama, Kanagawa (JP); Ryohta Matsufuji, Kanagawa (JP)

(72) Inventors: Kohta Akiyama, Kanagawa (JP); Yusuke Nonoyama, Kanagawa (JP); Ryohta Matsufuji, Kanagawa (JP)

(21) Appl. No.: 16/797,771

(22) Filed: Feb. 21, 2020

(30) Foreign Application Priority Data
Mar. 12, 2019 (JP) 2019-044577

(51) Int. Cl. B41J 2/14

(52) U.S. Cl. CPC B41J 2/1433

(57) ABSTRACT

A liquid discharge head includes a nozzle plate including a plurality of nozzles from each of which a liquid is discharged, and a channel member including a plurality of pressure chambers respectively communicating with the plurality of nozzles. The channel member includes a side wall in each of the plurality of pressure chambers, the side wall is perpendicularly bonded to the nozzle plate, a thickness of the side wall increases toward the nozzle plate, and the nozzle plate includes a flat surface in a periphery of each of the plurality of nozzles on a surface of the nozzle plate facing one of the plurality of pressure chambers.

### CROSS-REFERENCE TO RELATED APPLICATION

This patent application is based on and claims priority pursuant to 35 U.S.C. § 119(a) to Japanese Patent Application No. 2019-044577, filed on Mar. 12, 2019 in the Japan Patent Office, the entire disclosure of which is hereby incorporated by reference herein.

### BACKGROUND

### Technical Field

Aspects of the present disclosure relate to a liquid discharge head and a liquid discharge apparatus.

### Related Art

An image forming apparatus such as a printer, a facsimile, a copy machine, a plotter, and a multifunction peripheral (MFP) of the printer, the facsimile, the copy machine, and the plotter includes an image forming apparatus of a liquid-discharge recording type (inkjet recording apparatus) using a liquid discharge head to discharge a liquid as a recording head.

The liquid discharge head includes nozzles to discharge liquids, individual channels communicating with the nozzles, and pressure generators to pressurize the liquids in the individual channels. The pressure generators pressurize the liquid in the individual channels to discharge the liquids in the individual channels from the nozzles.

In the liquid discharge head, the nozzles, the individual channels, and the pressure generators (such as piezoelectric elements) are arranged with high density to form the nozzles with high density. Conversely, reduction of a space between adjacent individual channels reduces a rigidity of a partition wall separating the individual channels.

Thus, a nozzle surface and the partition wall may be deformed due to expansion and shrinkage (contraction) of the piezoelectric element. The deformation of the nozzle surface and the partition wall may affect discharge characteristics of the liquid discharge head such as reduction in a pressure applied to the liquid in the individual chambers, or reduction in a discharge speed.

Further, structural crosstalk may occur due to deformation of adjacent individual channels in the liquid discharge head that includes the nozzles arranged at high density.

### SUMMARY

In an aspect of this disclosure, a liquid discharge head includes a nozzle plate including a plurality of nozzles from each of which a liquid is discharged, and a channel member including a plurality of pressure chambers respectively communicating with the plurality of nozzles. The channel member includes a side wall in each of the plurality of pressure chambers, the side wall is perpendicularly bonded to the nozzle plate, a thickness of the side wall increases toward the nozzle plate, and the nozzle plate includes a flat surface in a periphery of each of the plurality of nozzles on a surface of the nozzle plate facing one of the plurality of pressure chambers.

### BRIEF DESCRIPTION OF THE SEVERAL VIEWS OF THE DRAWINGS

The aforementioned and other aspects, features, and advantages of the present disclosure will be better understood by reference to the following detailed description when considered in connection with the accompanying drawings, wherein:

FIG. 1 is a plan view of a liquid discharge head according to an embodiment of the present disclosure viewed from a nozzle surface;

FIG. 2 is a cross-sectional view of the liquid discharge head of FIG. 1 along line A-A;

FIGS. 3A to 3C are cross-sectional views of the liquid discharge head of FIG. 1 along line B-B;

FIG. 4 is a cross-sectional view of the liquid discharge head of FIG. 1 along line B-B according to a first embodiment of the present disclosure;

FIG. 5 is a cross-sectional view of the liquid discharge head of FIG. 1 along line B-B according to a second embodiment of the present disclosure;

FIG. 6 is a cross-sectional view of the liquid discharge head of FIG. 1 along line B-B according to a third embodiment of the present disclosure;

FIG. 7 is a perspective view of a liquid discharge apparatus including the liquid discharge head according to an embodiment of the present disclosure;

FIG. 8 is a side view of an entire structure of a mechanism of the liquid discharge apparatus including the liquid discharge head according to an embodiment of the present disclosure;

FIG. 9 is a plan view of a main portion of the mechanism of the liquid discharge apparatus including the liquid discharge head illustrated in FIG. 8; and

FIG. 10 is a schematic side view of an entire configuration of a mechanism of a liquid discharge apparatus including the liquid discharge head according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that have the same function, operate in a similar manner, and achieve similar results.

Although the embodiments are described with technical limitations with reference to the attached drawings, such description is not intended to limit the scope of the disclosure and all of the components or elements described in the embodiments of this disclosure are not necessarily indispensable. As used herein, the singular forms “a”, “an”, and “the” are intended to include the plural forms as well, unless the context clearly indicates otherwise.

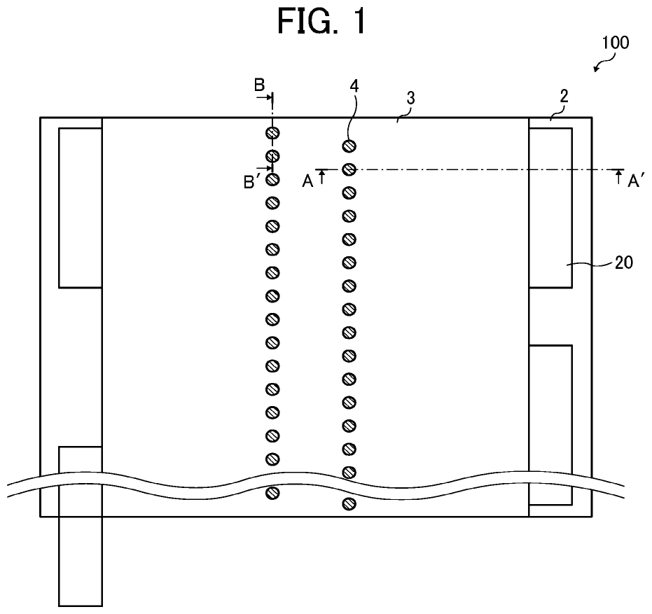

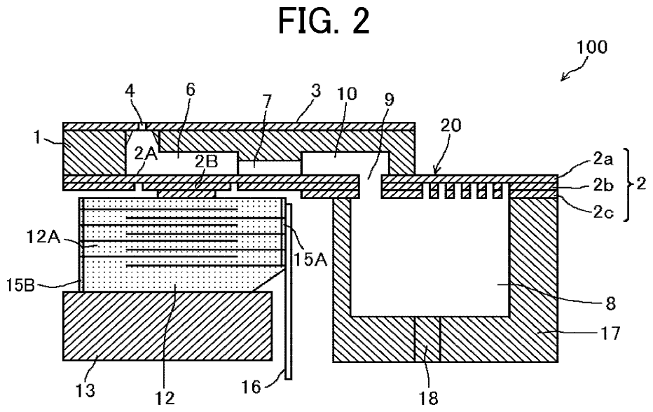

FIG. 1 is a schematic plan view of a liquid discharge head 100 according to an embodiment of the present disclosure in a view from a nozzle surface 3 s. FIG. 2 is a cross-sectional side view of the liquid discharge head 100 along line A-A in FIG. 1. Hereinafter, the “liquid discharge head” is simply referred to as “head”.

The head 100 includes a channel member 1 serving as a chamber substrate, a diaphragm 2 bonded to one surface of the channel member 1, and a nozzle plate 3 bonded to another surface of the channel member 1. Bonding of the channel member 1, the diaphragm 2, and the nozzle plate 3 forms pressure chambers 6 (individual channels) communicating with the nozzles 4 in the nozzle plate 3, and fluid restrictors 7 and communication chamber 10 respectively communicating with the pressure chamber 6 (individual channels). Hereinafter, the “individual channels” are also referred to as “pressure chambers”.

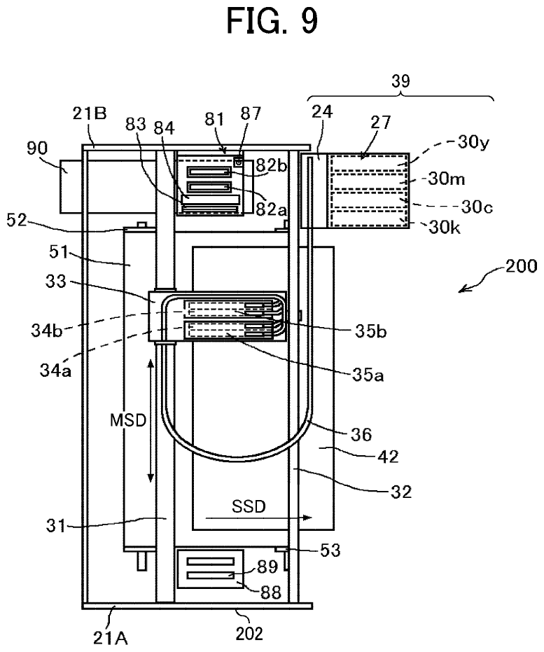

Each of the communication chamber 10 communicates with a common chamber 8 via a communication channel 9 in the diaphragm 2. The common chamber 8 is formed in a frame 17 described below. The liquid is supplied from a liquid feed unit 39 (see FIG. 9) to the common chamber 8. The liquid includes a recording liquid to be discharged onto a medium to record information on the medium. The liquid flowing into the common chamber 8 flows through the communication chamber 10 and the fluid restrictor 7, and the liquid is supplied to the pressure chamber 6. When the liquid is discharged from each nozzles 4, the liquid flows from the common chamber 8 into the pressure chamber 6 according to an amount of liquid discharged from the nozzle 4.

The channel member 1 includes openings and grooves such as the pressure chambers 6, the fluid restrictor 7, and the communication chamber 10. The openings and grooves are formed in the channel member 1 by machining a stainless steel (SUS) substrate by a Computer Numerical Control (CNC). Alternatively, the openings and grooves may be formed in the channel member 1 by anisotropic etching a single-crystal silicon substrate having a crystal plane orientation of (110) using an alkaline etching solution such as an aqueous potassium hydroxide solution (KOH). Further, the openings and grooves such as the pressure chambers 6 may be formed in the channel member 1 by etching the SUS substrate using an acidic etching liquid. Further, the pressure chamber 6, the nozzle plate 3, and the diaphragm 2 may be integrally formed by electroforming. Further, the openings and grooves may be formed in the channel member 1 by processing using a photosensitive resin or the like.

The diaphragm 2 includes nickel plates having a three-layer structure of a first layer 2a, a second layer 2b, and a third layer 2c from a side bonded to the pressure chamber 6. The diaphragm 2 may be manufactured by an electroforming process. The diaphragm 2 may be, for example, a lamination of a resin member such as polyimide and a metal plate such as a SUS substrate, or a substrate member formed of a resin material.

The nozzle plate 3 includes plurality of nozzles 4, a number of which corresponds to a number of the pressure chambers 6. The nozzle plate 3 is bonded to the channel member 1 with an adhesive. As a material of the nozzle plate 3, a substrate made of a metal material such as stainless steel or nickel, a resin material such as a polyimide resin film, a silicon material, or a composite material combining plurality of the materials as described above. Further, the nozzles 4 has an inner shape of a horn shape such as a substantially pillar shape or a substantially frustum of circular cone shape. An inner diameter of the nozzle 4 is about 20 μm in terms of a diameter on the nozzle surface 3s side.

The nozzle plate 3 includes a water-repellent layer subjected to a water-repellent surface treatment on a nozzle surface 3s of the nozzle plate 3. The nozzle surface 3s of the nozzle plate 3 is an outer surface of the nozzle plate 3 in a discharge direction of the liquid from the nozzles 4. The water-repellent layer is formed by a treatment selected in accordance with the physical properties of ink from, for example, polytetrafluoroethylene (PTFE)-Ni eutectoid plating, electrodeposition of fluororesin, vapor deposition of evaporative fluororesin (e.g., fluorinated pitch), for example.

Further, the water-repellent layer may be formed by a baking treatment after application of a solvent of a silicon-based resin or a fluorine-based resin on the nozzle surface 3s of the nozzle plate 3. Selecting and forming such the water-repellent layer on the nozzle surface 3s in accordance with the physical properties of the liquid can stabilize a droplet shape and flying characteristics of the liquid so that an image of high-quality can be obtained.

The diaphragm 2 includes vibration regions 2A (diaphragm portions) that are deformable regions formed of the first layer 2a. A number of the vibration regions 2A corresponds to the number of the pressure chambers 6. A convex portion 2B is formed by lamination of the second layer 2b and the third layer 2c on the first layer 2a at a center of each vibration regions 2A. Each of the convex portions 2B is bonded to a lamination type of a piezoelectric element 12A constituting a pressure generator (actuator).

In the present embodiment, a piezoelectric element member 12 is groove-processed processed (slit processed) by half-cut dicing to divide the piezoelectric element member 12 in a comb shape without separating each parts of the piezoelectric element substrate, thus forming the plurality of piezoelectric elements 12A and the pillars 12B. The piezoelectric element member 12 is fixed on a base 13 along an array direction of the piezoelectric element member 12. In the piezoelectric element member 12, a pillar 12B is provided between each of the plurality of piezoelectric elements 12A arrayed in a line, and the pillar 12B is a piezoelectric element not driven by driving signals. Each of the pillars 12B is bonded to the convex portions 2B at positions corresponding to partition walls 19 formed between the pressure chambers 6.

The piezoelectric element member 12 includes, for example, a piezoelectric layer made of lead zirconate titanate (PZT) having a thickness of 10 μm to 50 μm/layer and an internal electrode layer made of alloy of silver and paradium (AgPd) having a thickness of several μm/layer. The piezoelectric layers and the internal electrode layers are alternately laminated to form the piezoelectric element member 12. The internal electrode layers are alternately exposed at both end surfaces along a lamination direction of the piezoelectric layers and the internal electrode layers. Each of exposed end surfaces of the internal electrode layers is electrically connected to an individual electrode 15A and a common electrode 15B that are selection electrodes (external electrodes). The individual electrode 15A is connected to a head driver via a flexible print cable (FPC 16).

A piezoelectric constant of the piezoelectric element 12A is d33. The d33 indicates expansion and shrinkage (contraction) in a direction perpendicular to a surface of an internal electrode (thickness direction of the piezoelectric element 12A). The vibration region 2A is displaced by expansion and shrinkage (contraction) of the piezoelectric element 12A to cause the pressure chamber 6 to shrink (contract) or expand, thereby causing a pressure fluctuation in the liquid in the pressure chamber 6. When driving signals are applied to the piezoelectric element 12A and the piezoelectric element 14 is charged, the piezoelectric element 12A extends. When an electric charge of the piezoelectric element 12A is discharged, the piezoelectric element 12A shrinks (contracts) in a direction opposite an extending direction of the piezoelectric element 12A.

The piezoelectric element member 12 may displace in a d33 direction as a piezoelectric direciton to pressurize the liquid in the pressure chamber 6. Alternatively, the piezoelectric element member 12 may displace in a d31 direction as a piezoelectric direction to pressurize the liquid in the pressure chamber 6. In the head 100 according to the present embodiment, a configuration using displacement in the d33 direction is adopted.

A base 13 is preferably formed of a metal material. The base 13 made of the metal material can prevent storage of heat due to self-heating of the piezoelectric element member 12. Further, a frame 17 is bonded around the diaphragm 2 with an adhesive. The common chamber 8 is formed in the frame 17. The common chamber 8 supplies the liquid to each of the pressure chambers 6. The frame 17 includes an inlet 18 communicating with the common chamber 8. The liquid flown from the liquid feed unit 39 flows through the inlet 18 into common chamber 8. The liquid is supplied from the common chamber 8 to the pressure chamber 6 through the communication channel 9 in the diaphragm 2.

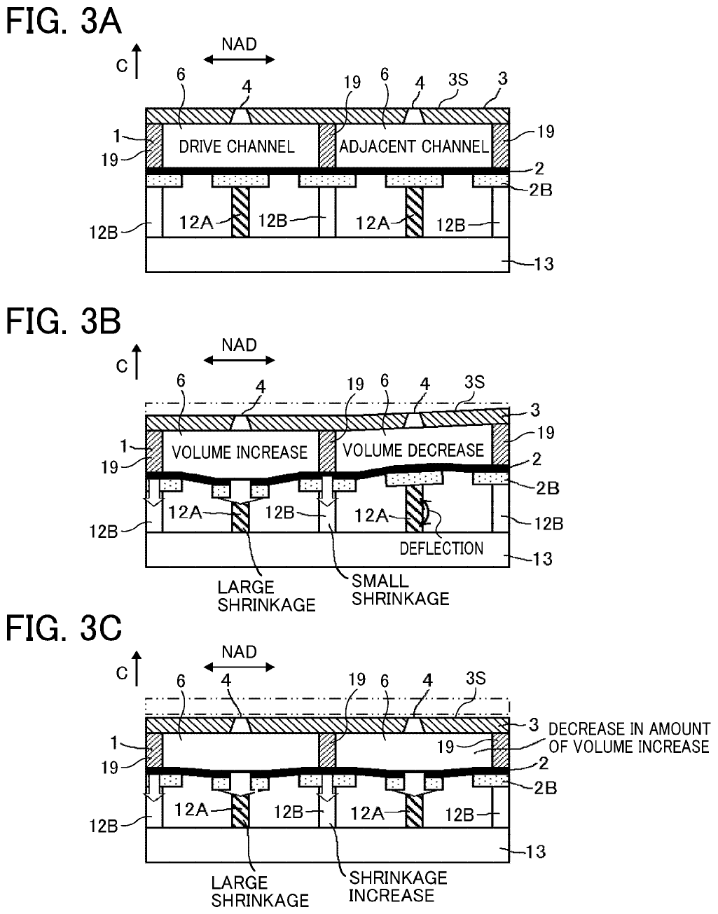

The common chamber 8 has a rectangular shape in plane in a nozzle array direction along which the pressure chambers 6 are arrayed. The nozzle array direction is indicated by arrow “NAD” in FIG. 3. The nozzle array direction NAD is a direction along which the nozzles 4 are arrayed. The nozzle array direction NAD is also referred to as a “longitudinal direction of common chamber”. At least one of a wall surfaces that forms the common chamber 8 is formed with the first layer 2a of the diaphragm 2. The head 100 includes a damper 20 having a lower rigidity than a rigidity of other wall surfaces formed by the frame 17.

The damper 20 may be formed of two layers instead of one layer. Alternatively, only the damper 20 may be made of a material different from the material of the diaphragm 2. Further, the damper 20 is desirably made of a material having low gas permeability such as, for example, metal Ni. However, the damper 20 may be formed of a resin film or the like.

In the head 100 thus configured, for example, when a voltage lower than a reference potential is applied to the piezoelectric element 12A, the piezoelectric element 12A shrinks (contracts). Accordingly, the vibration region 2A of the diaphragm 2 moves downward and the volume of the pressure chamber 6 increases, thus causing liquid to flow into the pressure chamber 6. When the voltage applied to the piezoelectric element 12A is raised, the piezoelectric element 12A extends in a direction of lamination of the piezoelectric element 12A. Accordingly, the vibration region 2A of the diaphragm 2 deforms in a direction toward the nozzle 4 and the volume of pressure chamber 6 reduces. Thus, a droplet of the liquid is pressurized and discharged from the nozzle 4.

When the voltage applied to the piezoelectric element 12A is returned to the reference potential, the vibration region 2A of the diaphragm 2 is returned to the initial position. Accordingly, the pressure chamber 6 expands to generate a negative pressure. Thus, the liquid is supplied from the common chamber 8 to the pressure chamber 6. After a vibration of a meniscus surface of the nozzle 4 is attenuated and stabilized, an operation for the next droplet discharge is started.

Note that the method of driving the head 100 is not limited to the above-described example (pull-push discharge). For example, pull discharge or push discharge may be performed in accordance with the way to apply a drive waveform to the piezoelectric element 12A. The pull discharge is a method of discharging the liquid by lowering a potential from the reference potential to shrink (contract) the piezoelectric element 12A to increase an internal volume of the pressure chamber 6, and then return the potential to the reference potential to return the diaphragm 2 to the initial position. The push discharge is a method of discharging the liquid by raising the potential from the reference potential to push the diaphragm 2 into the pressure chamber 6 side.

When a pressure wave is generated in the pressure chamber 6 to discharge the liquid from the nozzle 4 as described above, the pressure wave in the pressure chamber 6 is transmitted to common chamber 8 through the fluid restrictor 7, the communication chamber 10, and the communication channel 9. Thus, a pressure fluctuation may occur in the common chamber 8. However, vibration of the damper 20 can attenuate the pressure fluctuation transmitted from the pressure chamber 6 to the common chamber 8.

Thus, the damper 20 can prevent fluctuation of the pressure in the pressure chamber 6 that cause the head 100 unable to discharge the liquid at a required droplet volume and droplet speed. The damper 20 further can prevent leaking or mis-discharge of the liquid from the nozzles 4 by breakage of the nozzle meniscus. Thus, the head 100 can stably discharge the liquid from the nozzles 4.

Next, a mechanism of occurrence of structural crosstalk in the head 100 is described below.

FIG. 3 is a cross-sectional side view of the head 100 along a line B-B in FIG. 1. As illustrated in FIG. 3A, a drive channel and an adjacent channel adjacent to the drive channel are defined by the channel member 1 (partition walls 19).

As illustrated in FIG. 3B, when only the piezoelectric element 12A of the drive channel (left side) is driven and shrunk, and the piezoelectric element 12A of the adjacent channel (right side) is not driven, the piezoelectric element 12A of the drive channel pulls the diaphragm 2 and the partition wall 19 of the drive channel downward as indicated by arrow in FIG. 3B. The partition wall 19 partitions the pressure chambers 6. At time of shrinkage of the piezoelectric element 12A of the drive channel, a force that deforms the diaphragm 2 in a nozzle direction “C” also acts on the nozzle plate 3 via the partition wall 19. Thus, the force causes a deformation of the nozzle plate 3. The nozzle direction (nozzle discharge direction) is indicated by arrow “C” in FIGS. 3A to 3C.

Thus, as illustrated in FIG. 3B, when the piezoelectric element 12A of the drive channel is driven and shrunk (large shrinkage), a volume of the pressure chamber 6 of the drive channel increases. On the other hand, the piezoelectric element 12A of the adjacent channel is deflected by the deformation of the diaphragm 2 in the drive channel, and a volume of the pressure chamber 6 of the adjacent channel decreases. A shrinkage of the pillar 12B between the drive channel and the adjacent channel is smaller than the shrinkage of the piezoelectric element 12A of the drive channel.

Further, as illustrated in FIG. 3C, when the piezoelectric elements 12A of both the drive channel and the adjacent channel are driven and shrunk, an amount of increase in the volume of each of the pressure chambers 6 of the drive channel and the adjacent channel is reduced.

Thus, as illustrated in FIG. 3C, when both of the piezoelectric elements 12A of the drive channel and adjacent channel are driven and shrunk (large shrinkage), a volume of each of the pressure chambers 6 of the drive channel and the adjacent channel increases. A shrinkage of the pillar 12B between the drive channel and the adjacent channel is larger than the shrinkage of pillar 12B illustrated in FIG. 3B. That is, the shrinkage of the pillar 12B between the drive channel and the adjacent channel is substantially same as the shrinkage of the piezoelectric element 12A of the drive channel in FIG. 3C.

When a substantial amount of deformation (deformation volume) of the piezoelectric layer (PZT) is reduced due to the deformation of the nozzle plate 3, the pressure applied to the liquid in the pressure chamber 6 is reduced. Thus, the discharge speed of the liquid is also reduced. A degree of the effect of the deformation of the nozzle plate 3 increases as the rigidity of the partition walls 19 decreases and as a distance between adjacent nozzles 4 decreases.

Further, in the head 100 including the nozzles 4 arranged in a high-density, an influence of structural crosstalk increases since the distance between adjacent nozzles 4 is short.

An increase in a width of the partition wall 19 that increases the rigidity of the partition wall 19 in the pressure chamber 6 (individual channel) may reduce the crosstalk. An increase in the rigidity of the partition wall 19 reduces deformation of the pressure chamber 6. However, increase of the width of the partition wall 19 in the nozzle array direction NAD to increase the rigidity of the partition wall 19 may increase an interval between adjacent channels. Thus, the pressure chambers 6 may not be effectively arranged at high-density.

Next, a characteristic configuration of the present embodiment is described below.

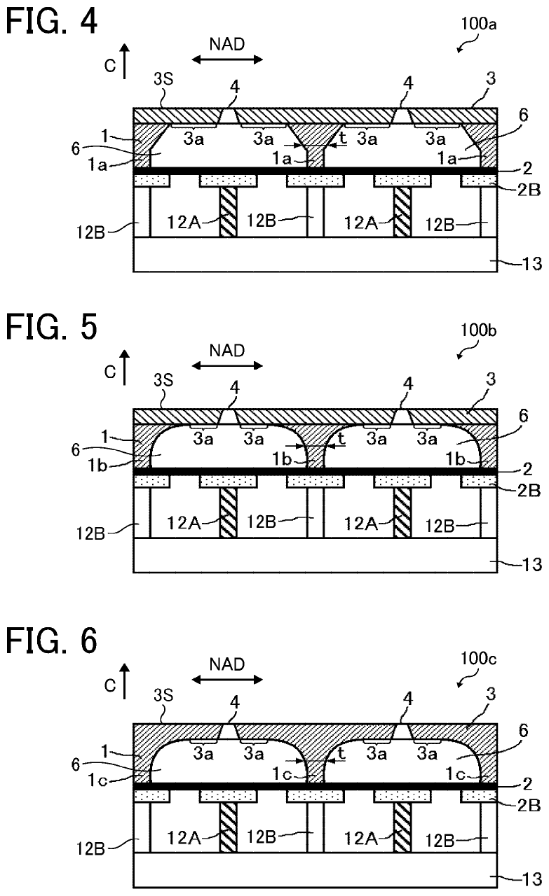

FIG. 4 is a cross-sectional view of the head 100 along line B-B of the head 100 in FIG. 1 according to the first embodiment of the present disclosure. The head 100a according to the present embodiment includes a side wall 1a formed in the channel member 1. The channel member 1 is bonded to the nozzle plate 3 in a direction substantially perpendicularly to the nozzle plate 3 to form the side wall 1a of the pressure chamber 6. The thickness of the side wall 1a gradually increases toward the nozzle plate 3. That is, the side wall 1a has a shape, the thickness “t” of which increases toward the nozzle plate 3. Thus, the thickness of the side wall 1gradually increases as the side wall 1a approaches the nozzle plate 3.

Therefore, the head 100a of the present embodiment can increase the rigidity of the nozzle plate 3 in the nozzle direction C (a direction perpendicular to the nozzle surface 3s) to reduce a deformation of the nozzle surface 3s in a thickness direction of the nozzle plate 3. Further, the head 100a can reduce occurrence of structural crosstalk in the head 100a even in a head 100 including nozzles 4 arranged at a high density.

A shape of the side wall Iₐ can be formed, for example, by a tapered punch used for press during manufacturing the channel member 1. Further, the shape of the side wall 1a also be formed by a method such as a tapered end mill during milling the channel member 1.

In the nozzle plate 3 according to the present embodiment, a periphery 3a of the nozzle 4 on the pressure chamber 6 side is formed by a plane (to have a flat surface) as illustrated in FIG. 4. That is, the periphery 3a of the nozzle plate 3 is a region between the nozzle 4 of the nozzle plate 3 and the side wall 1a of the channel member 1. The periphery 3a is formed by a plane (to have the flat surface) to separate the nozzles 4 from the side wall 1a of the channel member 1.

Thus, the head 100a can prevent an occurrence of a turbulent flow of the liquid near the nozzle 4 and reduce abnormal discharge or discharge bending even if there is a dimensional variation in a tapered side wall 1a in the channel member 1 or a burr in the tapered side wall 1a. Further, the head 100a can reduce manufacturing cost since it is not necessarily to highly accurately process a tapered side wall 1a in the channel member 1. A tapered surface of the side wall 1a may have a straight surface as illustrated in FIG, 4 or a curved surface as illustrated in FIG. 5 as described below.

Thus, the nozzle plate 3 includes a flat surface in a periphery 3a of each of the plurality of nozzles 4 on a surface of the nozzle plate 3 facing one of the plurality of pressure chambers 6.

### Second Embodiment

FIG. 5 is a cross-sectional view of the head 100b along line B-B of the head 100 in FIG. 1 according to a second embodiment of the present disclosure. Similarly to the first embodiment, the head 100a according to the present embodiment includes the channel member 1 bonded substantially perpendicular to the nozzle plate 3 to form the side wall 1b of the pressure chamber 6. The thickness of the side wall 1a gradually increases toward the nozzle plate 3.

However, the head 100b in the second embodiment is different from the head 100a in the first embodiment such that a bonding portion of the side wall 1b of the channel member 1 has a round (curved) shape. The bonding portion of the side wall 1b is disposed adjacent (closed) to the nozzle plate 3 to be bonded with the nozzle plate 3. Thus, the bonding portion of the side wall 1b of the channel member 1 of the head 100b in the second embodiment has a round (curved) surface, a curvature of which continuously changes.

The curved shape of the side wall 1b can be easily formed by, for example, milling using a ball-shaped end mill during manufacturing the channel member 1.

Also in the second embodiment, the periphery 3a of the nozzle 4 of the nozzle plate 3 on the pressure chamber 6 side is formed by a plane (to have a flat surface) to separate the nozzle 4 from the side wall 1b. Thus, the head 100b can prevent an occurrence of a turbulent flow of the liquid near the nozzle 4 and reduce abnormal discharge or discharge bending.

### Third Embodiment

FIG. 6 is a cross-sectional view of the head 100c along line B-B of the head 100 in FIG. 1 according to a third embodiment of the present disclosure. The head 100c according to the third embodiment differs from the heads 100a and 100b in the first and second embodiments in that the nozzle plate 3 and the side wall 1c of the channel member 1 are molded as a single unit of stainless steel.

For example, the nozzle plate 3 and the channel member 1 are molded as a single unit of the same material such as stainless steel.

Further, a connecting portion between the nozzle plate 3 and the side wall 1c of the channel member 1 has a round (curved) shape having a curved surface, a curvature of which continuously changes.

Also in the third embodiment, the periphery 3a of the nozzle 4 of the nozzle plate 3 on the pressure chamber 6 side is formed by a plane (to have a flat surface) to separate the nozzle 4 from the side wall 1c.

The round (curved) shaped side wall 1c can be easily formed by, for example, milling using a ball-shaped end mill during manufacturing the nozzle plate 3 and the channel member 1 molded as a single unit.

In the head 100c according to the third embodiment, the nozzle plate 3 and channel member 1 are molded as a single unit of high-rigidity stainless steel. Thus, an adhesive layer having low-rigidity interposed between the nozzle plate 3 and the channel member 1 becomes unnecessary. Thus, the head 100c according to the third embodiment can increase the rigidity of the nozzle plate 3 in the nozzle direction C (a direction perpendicular to the nozzle surface 3s) to further reduce a deformation of the nozzle surface 3s in a thickness direction of the nozzle plate 3. Further, the head 100c can further reduce an occurrence of structural crosstalk in the head 100c even if the head 100 includes nozzles 4 arranged at a high density.

Thus, the head 100c can prevent an occurrence of a turbulent flow of the liquid near the nozzle 4 and reduce abnormal discharge or discharge bending since the nozzle 4 is separated from the side wall 1c. Further, the head 100c can reduce manufacturing cost since it is not necessarily to highly accurately process a round (curved) side wall 1c in the channel member 1.

Further, a connection portion between the nozzle plate 3 and the side wall 1c of the channel member 1 is not limited to the round (curved) shape. For example, the connection portion may have a tapered shape. Further, a material used for the connection portion is not limited to stainless steel. For example, the connection portion may be molded as a single unit of the same material, for example, a single crystal silicon substrate.

Next, a liquid discharge apparatus 200 (image forming apparatus) according to an embodiment of the present disclosure including the head 100 according to an embodiment of the present disclosure is described below with reference to the drawings.

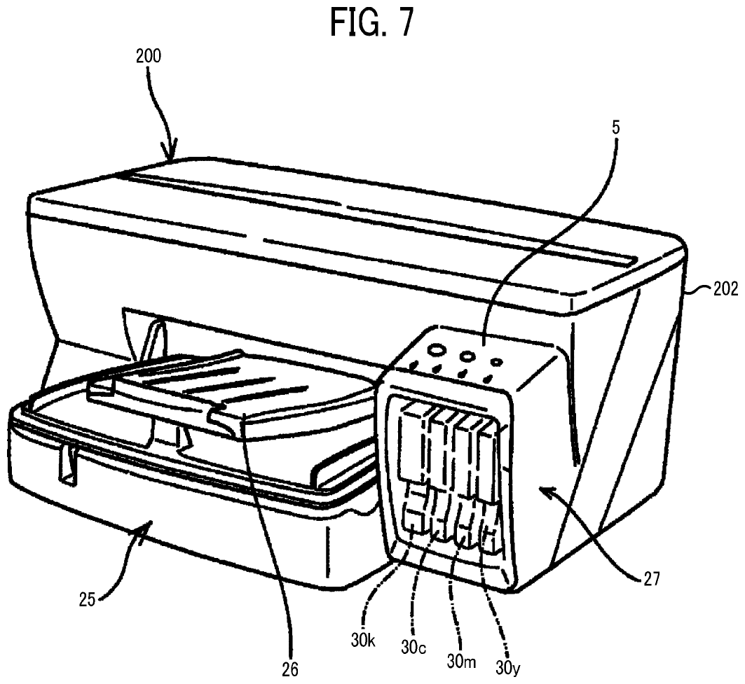

FIG. 7 is a perspective view of the liquid discharge apparatus 200 including the head 100 according to the present embodiment.

The liquid discharge apparatus 200 according to the present embodiment is an inkjet recording apparatus including the head 100 in the present embodiment. The liquid discharge apparatus 200 includes an apparatus body 202, a sheet feed tray 25, and an ejection tray 26. Further, the liquid discharge apparatus 200 includes a cartridge holder 27 to detachably mount ink cartridges 30k, 30c, 30m, and 30y on a front surface of the apparatus body 202.

The liquid discharge apparatus 200 includes an operation display 5 including operation buttons and a display on an upper surface of the liquid discharge apparatus 200. The ink cartridges 30k, 30c, 30m, and 30y are ink cartridges contain inks of respective colors of, black (Bk) ink, cyan (C) ink, magenta (N) ink, magenta (M) ink, and yellow (Y) ink. The ink cartridges 30k, 30c, 30m, and 30y are detachably mounted on the cartridge holder 27.

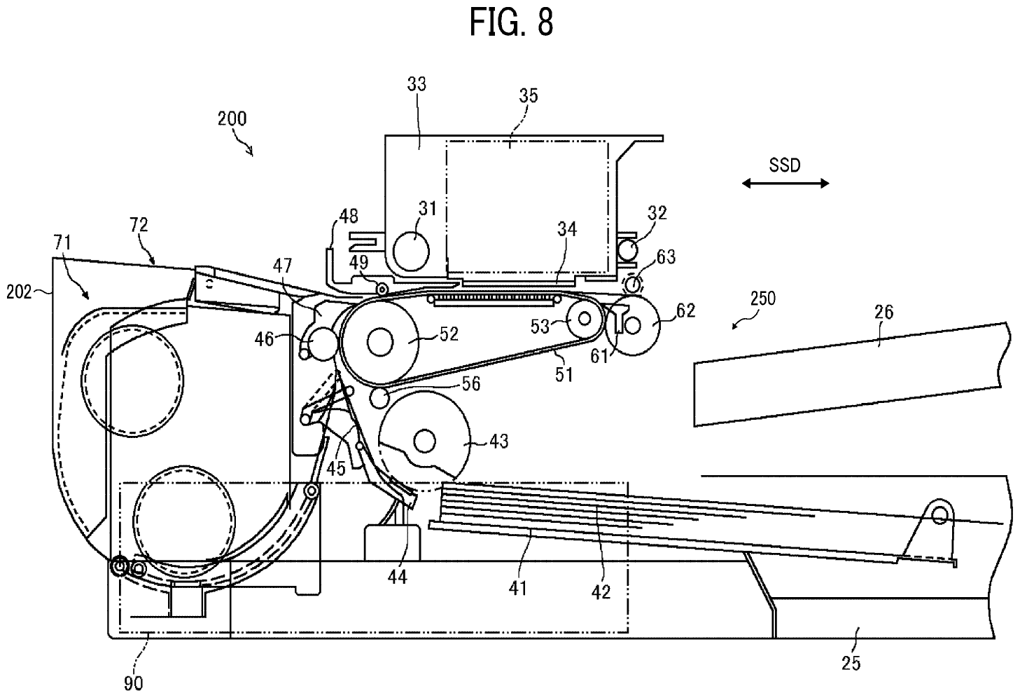

FIG. 8 is a side view of an entire structure of a mechanism of the liquid discharge apparatus 200 according to the present embodiment including the head 100 according to the present embodiment. FIG. 9 is a schematic plan view of a mechanism of the liquid discharge apparatus 200.

The liquid discharge apparatus 200 is a serial-type inkjet recording apparatus serving as an image forming apparatus that discharges a liquid onto the medium to form an image on the medium. The liquid discharge apparatus 200 includes a main guide rod 31 and a sub guide rod 32 laterally bridged between a left side plate 21A and a right-side plate 21B of an apparatus body. The main guide rod 31 and the sub guide rod 32 slidably support the carriage 33 in a main scanning direction indicated by arrow “MSD” in FIG. 9. The liquid discharge apparatus 200 includes a main scanning motor that moves and scans the carriage 33 in the main scanning direction MSD via a timing belt in FIG. 9.

Recording heads 34a and 34b to discharge ink droplets (liquids) of respective colors of yellow (Y), cyan (C), magenta (M), and black (Bk) are mounted on the carriage 33. The recording heads 34a are collectively and simply referred to as the “heads 34” when the recording heads 34a and 34b are not distinguished. Each of the heads 34 includes nozzle arrays each including the plurality of nozzles 4 arrayed in row in a sub-scanning direction indicated by arrow “SSD” perpendicular to the main scanning direction MSD indicated by arrow MSD in FIG. 9. The heads 34 are mounted to the carriage 33 so that ink droplets are discharged downward from the nozzles 4 of the heads 34.

Each heads 34 includes two arrays of nozzles 4. Then, one nozzle array of the head 34a discharges black (K) droplets, and another nozzle array of the head 34a discharges cyan (C) droplets. Further, one nozzle array of the head 34b discharges magenta (M) droplets, and another nozzle array of the head 34b discharges yellow (Y) droplets. Further, the head 34 may include the head 34 that includes nozzle arrays of respective colors on one nozzle surface of the head 34. Each of the nozzle arrays including a plurality of nozzles arrayed in a row.

The carriage 33 mounts head tanks 35a and 35b as second ink supply units to supply inks of respective colors corresponding to the nozzle arrays of the head 34. On the other hand, ink cartridges 30y, 30m, 30c, and 30k (main tanks) of the respective colors are detachably mounted on the cartridge holder 27. The liquid feed unit 39 includes a liquid feed pump 24 that sends liquids of four colors from the ink cartridges 30y, 30m, 30c, and 30k of the four colors to the head tanks 35a and 35b via supply tubes 36 of the four colors. The “head tanks 35a and 35b” are also collectively referred to as the “head tanks 35”.

The liquid discharge apparatus 200 further includes a sheet feeder 250 to feed sheets 42 stacked on a sheet stacker 41 of a sheet feed tray 25. The sheet feeder 250 includes a sheet feed roller 43 and a separation pad 44. The sheet feed roller 43 has a semicircular shape and separates and feeds the sheets 42 one by one from the sheet stacker 41. The separation pad 44 is disposed opposite to the sheet feed roller 43. The separation pad 44 is made of a material having a large coefficient of friction. The separation pad 44 is urged toward the sheet feed roller 43.

The liquid discharge apparatus 200 further includes a guide 45, a counter roller 46, conveyance guide 47, and a pressing member 48 to feed the sheet 42 fed from the sheet feeder 250 to the lower side of the head 34. The guide 45 guides the sheet 42. The pressing member 48 includes a leading-end pressing roller 49. The liquid discharge apparatus 200 includes a conveyance belt 51 serving as a conveyor to electrostatically attract the fed sheet 42 and convey the sheet 42 at a position facing the head 34.

The conveyance belt 51 is an endless belt. The conveyance belt 51 is stretched between a conveyance roller 52 and a tension roller 53. The conveyance belt 51 is designed to rotate in forward and reverse directions in a sub-scanning direction SSD. The direction in which the conveyance belt 51 conveys the sheets 42 is also referred to as a “belt conveyance direction” parallel to the sub-scanning direction SSD.

Further, the liquid discharge apparatus 200 includes a charging roller 56 as a charger to charge a surface of the conveyance belt 51. The charging roller 56 contacts a surface layer of the conveyance belt 51 and rotates according to a rotation of the conveyance belt 51. The liquid discharge apparatus 200 drives a sub-scanning motor to rotate the conveyance roller 52 via a timing belt so that the conveyance belt 51 circulates in the belt conveyance direction (sub-scanning direction SSD) in FIG. 8.

The liquid discharge apparatus 200 further includes a separation claw 61 to separate the sheet 42 from the conveyance belt 51, an ejection roller 62 and a spur 63 as an ejection roller, and the ejection tray 26 positioned below the ejection roller 62 as an ejection unit to eject the sheet 42 onto which the ink is discharged from the heads 34.

Further, the liquid discharge apparatus 200 includes a duplex unit 71 detachably attached to a back side of the apparatus body 202. The duplex unit 71 draws the sheet 42 sent back by reverse rotation of the conveyance belt 51 into the duplex unit 71. Then, the duplex unit 71 reverses the sheet 42 and conveys the sheet 42 toward a position between the counter roller 46 and the conveyance belt 51 again. An upper surface of the duplex unit 71 serves as a bypass tray 72.

Further, the liquid discharge apparatus 200 includes a maintenance unit 81 that maintains and recovers a discharge function of the nozzles 4 of the head 34. The maintenance unit 81 is disposed in a non-printing area on one side of the carriage 33 in the main scanning direction MSD (see FIG. 9).

The maintenance unit 81 includes caps 82a and 82b to respectively cap nozzle surfaces 4s of the heads 34a and 34b and a wiper blade 83 as a blade to wipe the nozzle surfaces 4s. The caps 82a and 82b are collectively referred to as the “caps 82”.

The maintenance unit 81 includes a dummy discharge receptacle 84 to receive liquid inks when a dummy discharge operation is performed. The dummy discharge operation discharges the liquids that do not contribute to recording (image forming) on a recording medium such as the sheet 42 to discharge thickened liquids to recover the discharge function of the nozzles of the head 34. The maintenance unit 81 further includes a carriage lock 87 to lock the carriage 33.

The liquid discharge apparatus 200 includes a waste liquid tank 90 to accommodate a waste liquid generated by a maintenance operation on a lower side of the maintenance unit 81. The waste liquid tank 90 is detachably attachable to the apparatus body 202.

Further, the liquid discharge apparatus 200 includes an ink collection unit 88 (dummy discharge receptacle) to receive the liquid discharged by the dummy discharge operation that do not contribute to image formation to discharge thickened ink during image formation in the non-printing area at another end in the main scanning direction MSD of the carriage 33. The ink collection unit 88 includes openings 89 extending along the nozzle array direction NAD of the head 34.

The sheets 42 are fed one by one from the sheet feed tray 25 in the image forming apparatus thus configured. Then, the sheet 42 is fed substantially vertically upward from the sheet feed tray 25 one by one, guided by the guide 45, and conveyed while being nipped between the conveyance belt 51 and the counter roller 46. A leading end of the sheet 42 is guided by the conveyance guide 47 and pressed against the conveyance belt 51 by the leading-end pressing roller 49. Thus, the conveyance direction of the sheet 42 is turned substantially 90°.

At the time of turning the conveyance direction of the sheet 42, a positive output and a negative output are applied to the charging roller 56 alternately, that is, an alternating voltage is applied on the charging roller 56. Thus, the conveyance belt 51 is charged in an alternating charge voltage pattern, that is, alternately charged plus and minus in a band manner with a predetermined width in the sub-scanning direction SSD that is a circulating direction of the conveyance belt 51. When the sheet 42 is fed onto the conveyance belt 51 alternately charged positive and negative, the sheet 42 is attracted by the conveyance belt 51 and is conveyed in the sub-scanning direction SSD by circular movement of the conveyance belt 51.

The liquid discharge apparatus 200 drives the heads 34 according to an image signal while moving the carriage 33 to discharge liquid inks onto the stopped sheet 42 to record one line and conveys the sheet 42 by a predetermined amount to record next line. In response to receiving a recording end signal or a signal indicating that a trailing edge of the sheet 42 has reached the recording area, the recording operation is finished and the sheet 42 is ejected on the ejection tray 26.

Thus, the liquid discharge apparatus 200 including the head 34 according to the present disclosure can stably form high quality images with reduced size and cost.

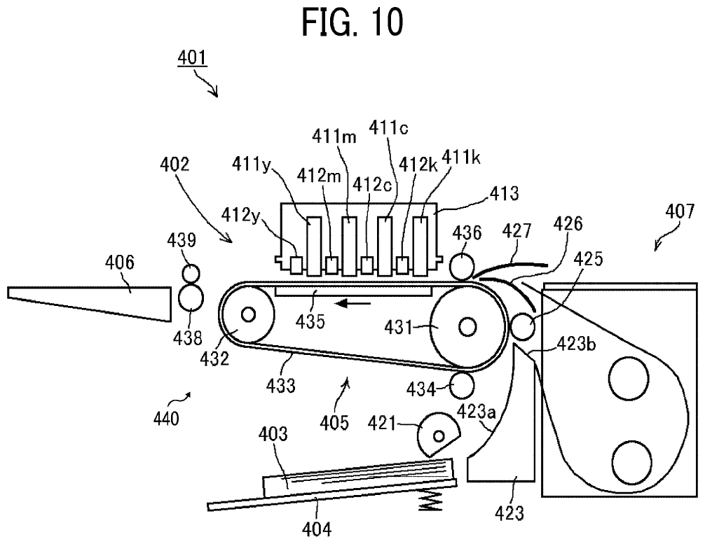

Next, another example of an image forming apparatus including a liquid discharge apparatus including the head 100 according to the present embodiment is described below with reference to FIG. 10.

FIG. 10 is a schematic side view of an overall configuration of a mechanism of a liquid discharge apparatus as an image forming apparatus 401 including the head 100 according to the present embodiment.

The image forming apparatus 401 is a full-line type image forming apparatus including a full-line type head. The image forming apparatus 401 includes an image forming unit 402 and a conveyance mechanism 405 to convey sheets 403 inside an apparatus body 440. The image forming apparatus 401 includes a sheet feed tray 404 capable of stacking a large number of the sheets 403 below the apparatus body 440.

When the sheet 403 fed from the sheet feed tray 404 is conveyed to an image forming unit 402, the image forming unit 402 records a desired image onto the sheet 403. Then, the sheet 403 is ejected to an ejection tray 406 mounted on a rear side of the apparatus body 440. The sheet 403 is conveyed in a conveyance direction indicated by arrow in FIG. 10.

The image forming unit 402 includes line heads 411y, 411m, 411c, and 411k, each of which is configured by the head 100 according to the present embodiment. The line heads 411y, 411m, 411c, and 411k are collectively referred to as the “line heads 411”. The line heads 411 integrally and respectively include liquid tanks accommodating liquids serving as recording liquids of respective colors. Each of the line heads 411 includes a nozzle array having a length in a width direction of the sheet 403 perpendicular to the conveyance direction of the sheet 403. The line heads 411 are mounted on a head holder 413 so that a nozzle surface of each of the line heads 411 faces downward.

Further, the image forming apparatus 401 includes maintenance units 412y, 412m, 412c, and 412k to respectively maintain and recover performance of the line heads 411y, 411m, 411c, and 411k. Hereinafter, the maintenance units 412y, 412m, 412c, and 412k are collectively referred to as “maintenance units 412” when colors are not distinguished. During a maintaining operation of the line head 411, such as a purging process and a wiping process, the line head 411 and the maintenance unit 412 are relatively moved so that a cap that constitutes the maintenance unit 412 faces a nozzle surface of the line head 411.

Here, the line heads 411 are arranged to discharge droplets of each color in an order of black, cyan, magenta, and yellow from an upstream in the conveyance direction of the sheet 403. However, an arrangement of the line heads 411 and a number of colors of the line heads 411 according to the present embodiment is not limited to the embodiments as described above. The line head 411 may include a single or a plurality of heads that includes a plurality of nozzle arrays to discharge liquids of respective colors. The line head 411 and the liquid tank to supply liquid to the line head 411 may form a single body, or the line head 411 and the liquid tank may be separated. The liquid tank may be a liquid cartridge detachably attachable to the line head 411.

The sheet 403 in the sheet feed tray 404 is separated one by one by a sheet feed roller 421 (half-moon roller) and a separation pad, and is fed into the apparatus body 440. Then, the sheet 403 is fed between a registration roller 425 and a conveyance belt 433 along a guide surface 423a of a conveyance guide 423. Then, the sheet 403 is fed to the conveyance belt 433 of the conveyance mechanism 405 via a guide 426 at a predetermined timing.

The conveyance guide 423 also includes a guide surface 423b to guide the sheet 403 fed from the duplex unit 407. Further, the image forming apparatus 401 includes a guide 427 to guide the sheet 403 returned from the conveyance mechanism 405 again to the duplex unit 407 during the duplex printing.

The conveyance mechanism 405 includes an endless conveyance belt 433 extending between a conveyance roller 431, which is a driving roller, and a driven roller 432, and a charging roller 434 to charge the conveyance belt 433. Further, the conveyance mechanism 405 includes a platen 435 that maintains flatness of the conveyance belt 433 at a portion facing the image forming unit 402 and a pressing roller 436 that presses the sheet 403 fed from the conveyance belt 433 against the conveyance roller 431.

Further, the conveyance mechanism 405 includes a cleaning roller and a discharge roller. The cleaning roller is a cleaning device to remove a liquid (ink) attached to the conveyance belt 433. The cleaning roller is made of a porous body or the like. The discharge roller is mainly made of conductive rubber to remove electricity from (discharge) the sheet 403.

The image forming apparatus 401 includes an ejection roller 438 and a spur 439 to feed the sheet 403 on which an image is recorded to an ejection tray 406 downstream of the conveyance mechanism 405.

In the image forming apparatus 401 thus configured, the conveyance belt 433 moves around in a conveyance direction indicated by the arrow in FIG. 10. The conveyance belt 433 contacts with the charging roller 434 to which a high potential voltage is applied. Then, when the sheet 403 is fed onto the conveyance belt 433 charged with the high potential voltage, the sheet 403 is electrostatically attracted to the conveyance belt 433. With attraction of the sheet 403 onto the conveyance belt 433, the sheet 403 is strongly attracted to the conveyance belt 433 so that warpage and unevenness of the sheet 403 are corrected. Thus, a highly flat surface is formed on the sheet 403.

Then, the sheet 403 is moved by rotating the conveyance belt 433, and a droplet is discharged from the line head 411 onto the sheet 403 to form a required image on the sheet 403. The sheet 403 on which the image has been recorded is discharged to the ejection tray 406 by the ejection roller 438.

The line-type image forming apparatus 401 includes the line head 411 according to the present embodiment thus can allow stable formation of high-quality images with smaller apparatus size and lower cost.

Next, clear definitions of terms used in the present embodiments are given below.

The “liquid discharge apparatus” is a device that includes a liquid discharge head or a liquid discharge device and drives the liquid discharge head to discharge a liquid. The liquid discharge apparatus may be, for example, an apparatus capable of discharging liquid to a material to which liquid can adhere and an apparatus to discharge liquid toward gas or into liquid.

The “liquid discharge apparatus” may include devices to feed, convey, and eject the material on which liquid can adhere. The liquid discharge apparatus may further include a pretreatment apparatus to coat a treatment liquid onto the material, and a post-treatment apparatus to coat a treatment liquid onto the material, onto which the liquid has been discharged.

The “liquid discharge apparatus” may be, for example, an image forming apparatus to form an image on a sheet by discharging ink, or a three-dimensional fabrication apparatus to discharge a fabrication liquid to a powder layer in which powder material is formed in layers to form a three-dimensional fabrication object.

The liquid discharge apparatus is not limited to an apparatus to discharge liquid to visualize meaningful images, such as letters or figures. For example, the liquid discharge apparatus may be an apparatus to form arbitrarily images, such as arbitrarily patterns, or fabricate three-dimensional images.

The above-described term “material on which liquid can be adhered” represents a material on which liquid is at least temporarily adhered, a material on which liquid is adhered and fixed, or a material into which liquid is adhered to permeate.

Examples of the “material on which liquid can be adhered” include recording media, such as paper sheet, recording paper, recording sheet of paper, film, and cloth, electronic component, such as electronic substrate and piezoelectric element, and media, such as powder layer, organ model, and testing cell. The “material on which liquid can be adhered” includes any material on which liquid is adhered, unless particularly limited.

Examples of the “material on which liquid can be adhered” include any materials on which liquid can be adhered even temporarily, such as paper, thread, fiber, fabric, leather, metal, plastic, glass, wood, ceramic, construction materials (e.g., wall paper or floor material), and cloth textile.

Further, the term “liquid” includes any liquid having a viscosity or a surface tension that can be discharged from the head. However, preferably, the viscosity of the liquid is not greater than 30 mPa·s under ordinary temperature and ordinary pressure or by heating or cooling. Examples of the liquid include a solution, a suspension, or an emulsion that contains, for example, a solvent, such as water or an organic solvent, a colorant, such as dye or pigment, a functional material, such as a polymerizable compound, a resin, or a surfactant, a biocompatible material, such as DNA, amino acid, protein, or calcium, or an edible material, such as a natural colorant. Such a solution, a suspension, or an emulsion can be used for, e.g., inkjet ink, surface treatment solution, a liquid for forming components of electronic element or light-emitting element or a resist pattern of electronic circuit, or a material solution for three-dimensional fabrication.

The “liquid discharge apparatus” may be an apparatus to relatively move the head and a material on which liquid can be adhered. However, the liquid discharge apparatus is not limited to such an apparatus. For example, the liquid discharge apparatus may be a serial head apparatus that moves the head or a line head apparatus that does not move the head.

Examples of the “liquid discharge apparatus” further include a treatment liquid coating apparatus to discharge the treatment liquid to a sheet to coat the treatment liquid on a sheet surface to reform the sheet surface. Examples of the “liquid discharge apparatus” further include an injection granulation apparatus in which a composition liquid including raw materials dispersed in a solution is injected through nozzles to granulate fine particles of the raw materials.

The “liquid discharge device” is an assembly of parts relating to liquid discharge. The term “liquid discharge device” represents a structure including the head and a functional part(s) or mechanism combined to the head to form a single unit. For example, the “liquid discharge device” includes a combination of the head with at least one of a head tank, a carriage, a supply unit, a maintenance unit, and a main scan moving unit to form a single unit.

Here, examples of the “single unit” include a combination in which the head and a functional part(s) or unit(s) are secured to each other through, e g , fastening, bonding, or engaging, and a combination in which one of the head and a functional part(s) or unit(s) is movably held by another. The head may be detachably attached to the functional part(s) or unit(s) s each other.

For example, the head and the head tank may form the liquid discharge device as a single unit. Alternatively, the head and the head tank coupled (connected) with a tube or the like may form the liquid discharge device as a single unit. A unit including a filter may be added at a position between the head tank and the head of the liquid discharge device.

In another example, the head and the carriage may form the liquid discharge device as a single unit.

In still another example, the liquid discharge device includes the head movably held by a guide that forms part of a main scan moving unit, so that the head and the main scan moving unit form a single unit. The liquid discharge device may include the head, the carriage, and the main scan moving unit that form a single unit.

In still another example, a cap that forms part of a maintenance unit may be secured to the carriage mounting the head so that the head, the carriage, and the maintenance unit form a single unit to form the liquid discharge device.

Further, in another example, the liquid discharge device includes tubes connected to the head to which the head tank or the channel member is attached so that the head and a supply unit form a single unit. Liquid is supplied from a liquid reservoir source to the head via the tube.

The main scan moving unit may be a guide only. The supply unit may be a tube(s) only or a loading unit only.

The term “liquid discharge head” used herein is a functional component to discharge or jet liquid from nozzles. Examples of an energy source to generate energy to discharge liquid include a piezoelectric actuator (a laminated piezoelectric element or a thin-film piezoelectric element), a thermal actuator that employs a thermoelectric conversion element, such as a heating resistor, and an electrostatic actuator including a diaphragm and opposed electrodes.

Note that the term “recording sheet” is not limited to sheet of paper but represents a material to which ink droplets or other liquid can adhere. For example, a recording sheet may be an overhead projector (OHP) sheet, fabric, glass, or a substrate, and be used as a synonym of a recorded medium, a recording paper, or a recording sheet of paper. The terms “image formation”, “recording”, “printing”, and “image printing” are used herein as synonyms for one another.

The term “ink” is not limited to “ink” in a narrow sense, unless specified, but is used as a generic term for any types of liquid usable as targets of image formation. For example, the term “ink” includes recording liquid, fixing solution, DNA sample, resist, pattern material, resin, and so on.

The term “image” used herein is not limited to a two-dimensional image and includes, for example, an image applied to a three-dimensional object and a three-dimensional object itself formed as a three-dimensionally molded image.

The embodiments of the present disclosure has been described in detail above. Numerous additional modifications to the above-described embodiment and variations are possible. It is therefore to be understood that, within the scope of the appended claims, the disclosure of this patent specification may be practiced otherwise than as specifically described herein. For example, a plurality of embodiments described above may be combined together.

Numerous additional modifications and variations are possible in light of the above teachings. It is therefore to be understood that, within the scope of the above teachings, the present disclosure may be practiced otherwise than as specifically described herein. With some embodiments having thus been described, it is obvious that the same may be varied in many ways. Such variations are not to be regarded as a departure from the scope of the present disclosure and appended claims, and all such modifications are intended to be included within the scope of the present disclosure and appended claims.

What is claimed is:

1. A liquid discharge head comprising:
a nozzle plate including a plurality of nozzles from each of which a liquid is discharged; and
a channel member including a plurality of pressure chambers respectively communicating with the plurality of nozzles,
wherein the channel member includes a side wall in each of the plurality of pressure chambers,
the side wall is perpendicularly bonded to the nozzle plate,
a thickness of the side wall increases toward the nozzle plate, and
the nozzle plate includes a flat surface in a periphery of each of the plurality of nozzles on a surface of the nozzle plate facing one of the plurality of pressure chambers.

2. The liquid discharge head according to claim 1,
wherein a bonding portion of the side wall to the nozzle plate has a tapered shape.

3. The liquid discharge head according to claim 2,
wherein a bonding portion of the side wall to the nozzle plate has a curved shape.

4. The liquid discharge head according to claim 1,
wherein the nozzle plate and the channel member are molded as a single unit of a same material.

5. The liquid discharge head according to claim 4,
wherein the nozzle plate and the channel member are made of stainless steel.

6. A liquid discharge apparatus comprising the liquid discharge head according to claim 1.
